(19) United States
(12) Patent Application Publication
(10) Pub. No.: US 2022/0122354 A1
(43) Pub. Date: Apr. 21, 2022

(54) SKIN TONE DETERMINATION AND FILTERING

(71) Applicant: Pinterest, Inc., San Francisco, CA (US)

(72) Inventors: Aleksandr Burdin, San Francisco, CA (US); Anqi Guo, San Francisco, CA (US); Charles Joseph Rosenberg, Cupertino, CA (US); Cindy Xinwei Zhang, Los Gatos, CA (US); David Ding-Jia Xue, San Francisco, CA (US); Dmitry Olegovich Kislyuk, San Francisco, CA (US); Emma Catherine Herold, San Francisco, CA (US); Eric Tzeng, Berkeley, CA (US); Jeffrey Harris, Oakland, CA (US); Joshua Richard Beal, San Francisco, CA (US); Long Cheng, San Francisco, CA (US); Nadia Fawaz, Santa Clara, CA (US); Rahul Rekha Gupta, Berkeley, CA (US); Dong Huk Park, Albany, CA (US); Shana Hu, San Francisco, CA (US); Vy Do Phan, Sunnyvale, CA (US); Yixue Li, San Francisco, CA (US)

(21) Appl. No.: 17/564,004

(22) Filed: Dec. 28, 2021

Related U.S. Application Data
(63) Continuation of application No. 16/906,088, filed on Jun. 19, 2020.

(51) Int. Cl. G06V 20/20; G06V 10/56; G06V 40/16; G06V 10/25; G06T 11/00; G06F 16/538

(52) U.S. Cl. CPC G06V 20/20; G06V 10/56; G06V 40/171; G06F 16/538; G06V 40/161; G06T 11/00; G06V 10/25

(57) ABSTRACT

Described are systems and methods for extracting parameters associated with a look/beauty aesthetic presented in a content item such as an image or a video. The extracted parameters can be used to identify beauty products that can be used to create a similar look/beauty aesthetic and to render the beauty product on a streaming live-feed video of the user so that the user can assess how the product looks on the user. Aspects of the disclosure also relate to classifying content items presenting a look/beauty aesthetic based on a dominant skin tone present in the content item.

### CROSS-REFERENCE TO PRIOR APPLICATIONS

This application is a continuation application of U.S. patent application Ser. No. 16/906,088, which was filed on Jun. 19, 2020, and is hereby incorporated by reference herein in its entirety.

### BACKGROUND

The amount of accessible content is ever expanding. This is particularly true in areas such as fashion and beauty. For example, content showing various beauty looks, makeup applications, trends, celebrity looks etc. can seem to be never-ending. Although content in connection with fashion and beauty is ever expanding, it can be difficult to identify the specific products shown in the content and how those products may appear when used by the consumers of the content.

### BRIEF DESCRIPTION OF THE DRAWINGS

FIG. 1 is block diagram illustrating an exemplary network environment for implementing embodiments of the present disclosure.

FIG. 2 is a representation of an exemplary presentation of a content item presenting a beauty aesthetic in accordance with embodiments of the present disclosure.

FIG. 3 is a representation of an exemplary presentation of a streaming live-feed video in accordance with embodiments of the present disclosure.

FIGS. 4A, 4B, and 4C are representations of exemplary presentations of identified and/or recommended beauty products and additional content items presenting beauty aesthetics in accordance with embodiments of the present disclosure.

FIG. 5 is a representation of an exemplary presentation of a streaming live-feed video in accordance with embodiments of the present disclosure.

FIG. 6 is a flow diagram of an exemplary process for extracting parameters associated with a beauty aesthetic in accordance with embodiments of the present disclosure.

FIG. 7 is a flow diagram of an exemplary process for identifying additional content items in accordance with embodiments of the present disclosure.

FIG. 8 is a flow diagram of an exemplary process for determining a dominant skin tone in accordance with embodiments of the present disclosure.

FIG. 9 is a block diagram illustrating an exemplary computer readable medium encoded with instructions, in accordance with embodiments of the present disclosure.

FIG. 10 is a block diagram illustrating an exemplary computing system (or computing device) configured for implementing embodiments of the present disclosure.

### DETAILED DESCRIPTION

As is set forth in greater detail below, embodiments of the present disclosure are generally directed to systems and methods for identifying a look (e.g., a beauty aesthetic) in a content item (e.g., an image, a video, etc.) and rendering the identified look on a content item associated with the user (e.g., a live-feed video of the user, a selfie, an existing image, etc.) of the content. For example, a user can provide and/or identify (e.g., via a client device) a content item, which can include an image with a visual representation of at least a portion of a body part (e.g., a face, a hand, toes, nails, hair, etc.) having a look/beauty aesthetic that may be achieved or created through the application of one or more beauty products (e.g., lipstick, eyeshadow, mascara, eyeliner, foundation, concealer, powder, blush, eye pencil, nail polish, toe polish, hair dye, hair style, hair extensions, etc.). Alternatively, the content item can include a visual representation of a beauty product itself. Embodiments of the present disclosure can process the content item to extract parameters associated with the beauty products in the content item and identify beauty products that may be used to achieve the same or similar look/beauty aesthetic. For example, parameters associated with the applied beauty products that can be extracted from the content item can include a color, a gloss, an amount of application, an opacity, a glitter, a glitter size, a glitter density, a shape of application, an intensity, etc. Based on the extracted parameter(s), one or more beauty products (or similar beauty products) used to create the look/beauty aesthetic, or a similar look/beauty aesthetic, can be identified. The identified beauty products can then be rendered on a content item associated with the user (e.g., a live-feed video of the user, a “selfie,” etc.) so that a consumer can assess the appearance of the beauty products on him/her (e.g., his/her face, hands, hair, nails, etc.) in the live content item associated with the user. According to aspects of the present disclosure, any such content items associated with a user are preferably not stored, saved, and/or otherwise maintained by the computer system implementing embodiments of the present disclosure.

Embodiments of the present disclosure can also identify and present additional content items to the user based on a user provided content item. For example, a corpus of additional content items (e.g., an image, a video, etc.), each having an image and a corresponding visual representation of a look/beauty aesthetic, can be stored and maintained in a data store. Similar to the processing and extraction of parameters in the user provided content item, each of the corpus of additional content items can be processed to extract certain parameters associated with the look/beauty aesthetic, beauty products, etc. presented in each additional content item. After the parameters have been extracted from the user provided content item and the corpus of additional content items, the parameters can be associated and stored with the additional content items. The stored parameters can then be used to identify additional content items. For example, the parameters extracted from the user provided content item can be compared against the parameters extracted from the corpus of additional content items to identify additional content items that have looks/beauty aesthetics that may be similar, be related in certain aspects, be a contrasting look, be a recommended look, be an alternative look, etc. The looks/beauty aesthetics presented in the additional content items can also be rendered on a user content item, such as a live-feed streaming video of the user or a selfie, so that the user can assess the appearance of the beauty products identified in the additional content items on his/her face in the live-feed streaming video. According to aspects of the present disclosure, any such content items associated with a user are preferably not stored, saved, and/or otherwise maintained by the computer system implementing embodiments of the present disclosure.

According to certain aspects of the present disclosure, processing the corpus of additional content items can also include identifying a skin tone associated with the look/beauty aesthetic presented in each of the additional content items. This can allow a user to filter or choose to see looks/beauty aesthetics only associated with a certain skin tone. To associate a skin tone with each of the corpus of additional content items, a dominant skin tone can be extracted from each of the additional content items. The dominant skin tone can then be processed and compared to certain various predetermined thresholds to classify each additional content item in one of a plurality of categories based on the identified dominant skin tone. A user can then opt to be presented additional content items only having looks/beauty aesthetics associated with a certain skin tone.

Although embodiments of the present disclosure are described primarily with respect to lipstick, embodiments of the present disclosure may be applicable to other any other types of looks/beauty aesthetics, and/or beauty products, such as, for example, lipstick, eyeshadow, mascara, eyeliner, foundation, concealer, powder, blush, eye pencil, nail polish, toe polish, hair dye, hair style, hair extensions, etc.

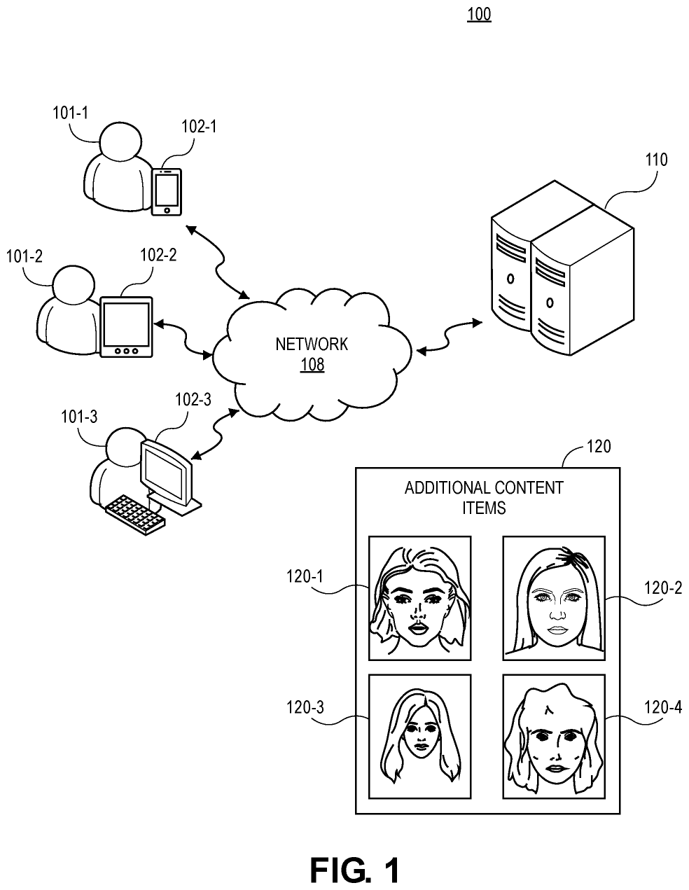

FIG. 1 shows an exemplary system 100 according to embodiments of the present disclosure. As shown in FIG. 1, users 101-1, 101-2, and 101-3 can, via client devices 102-1, 102-2, and 102-3, respectively, access content via network 108. For example, each of users 101-1, 101-2, and 101-3 can interact with content system 110 via applications executed on client devices 102-1, 102-2, and 102-3, respectively, through network 108. Client devices 102-1, 102-2, and 102-3 can be any type of computing device, such as a smartphone, tablet, laptop computer, desktop computer, wearable, etc.

According to embodiments of the present disclosure, users 101-1, 101-2, and 101-3 may, via client devices 102-1, 102-2, and 102-3, identify and/or provide a content item having an image with a visual representation of a look/beauty aesthetic of interest to content system 110. This can include, for example, any content (e.g., images, videos, etc.) that may include an image of at least a portion of a body part (e.g., a face, a hand, toes, nails, hair, etc.) having a look/beauty aesthetic. Alternatively, users 101-1, 101-2, and 101-3 may, via client devices 102-1, 102-2, and 102-3, provide a content item of a beauty product itself. According to aspects of the present disclosure, the content can include an image generated using one or more cameras of the client devices 102-1, 102-2, or 102-3, an image from memory of client devices 102-1, 102-2, or 102-3, an image stored in a memory that is external to client devices 102-1, 102-2, or 102-3, an image provided by content system 110, and/or an image from another source or location. The look/beauty aesthetic presented in the content item can include the application of one or more beauty products and/or styles (e.g., lipstick, eyeshadow, mascara, eyeliner, foundation, concealer, powder, blush, eye pencil, nail polish, toe polish, hair dye, hair style, hair extensions, hair perm, etc.) which, when combined, can contribute to the overall beauty aesthetic presented in the content item.

In the content item presented by the user, content system 110 can extract certain parameters associated with the look/beauty aesthetic and/or beauty product presented in the content item provided by the user, and, based on the extracted parameters, identify beauty products (or similar beauty products) that may be used to achieve the same or similar look/beauty aesthetic as the one presented in the content item. Content system 110 can also render the identified beauty product on a content item associated with the user (e.g., a live-feed streaming video, a selfie, an existing image, etc.) of any of users 101-1, 101-2, and 101-3 on client devices 102-1, 102-2, and 102-3, respectively. For example, after a beauty product has been identified, a user may be able to opt to see how the beauty product may appear on his/her face. Accordingly, the user may request that the beauty product is rendered on a content item presenting a visual representation of the user. For example, the user can activate a camera associated with the client device and initiate a live-feed streaming video, capture a selfie, select an existing image, etc. of him/herself. Content system 110 can then provide parameters to client device 102-1, 102-2, and 102-3 to facilitate rendering of the beauty product on the content item (e.g., the live-feed streaming video, the selfie, the existing image, etc.) locally on client device 102-1, 102-2, and 102-3. Alternatively, the content item can be provided to content system 110 and content system 110 can then render the beauty product on the face of the user in the content item and transmit it back to the client device in substantially real-time.

The content item, which can include an image with a visual representation of a look/beauty aesthetic of interest, provided by any of users 101-1, 101-2, and 101-3 via client devices 102-1, 102-2, and 102-3 may include an image with a visual representation of a face having lipstick and eyeshadow applied thereon. Content system 110 can utilize a face detection algorithm to detect features, regions of interest, landmarks, etc. presented in the image. For example, in an image of a face having lipstick and eyeshadow applied thereon, the detection algorithm can identify the lips and the eyes as regions of interest. According to certain aspects of the present disclosure, the detection and identification of regions of interest can be performed by a trained network (e.g., a trained classifier, a machine learning system, a deep learning system, a trained neural network, etc.). Alternatively, other approaches can be utilized such as image segmentation algorithms, edge detection algorithms, etc. Areas in the image not identified as regions of interest can then be removed from the image, so as to crop the identified regions of interest (e.g., the lips and the eyes) from the remainder of the image. For each remaining region of interest, certain parameters associated with the beauty product applied in each region of interest can be extracted. For example, in the lip region, a color, gloss, opacity, etc. of the lipstick shown in the image can be extracted. In connection with the eye regions, a color, a shape, an opacity, an amount, etc. associated with the eyeshadow can be extracted. Other parameters, such as, for example, a glitter, a glitter size, a glitter density, a shape of application, a shimmer, an intensity, etc. can also be extracted. For example, each pixel in the regions of interest can be processed to extract parameters such as gloss, red-green-blue (RGB) values, etc. Additionally, the extracted parameters can vary for each type of beauty product applied in the region of interest.

Alternatively, the content item provided by any of users 101-1, 101-2, and 101-3 via client devices 102-1, 102-2, and 102-3 may include an image with a visual representation of a beauty product itself. Content system 110 can detect the visual representation of the product and identify the portion of the product that is applied (e.g., remove areas showing packaging, etc.) as the region of interest. According to certain aspects of the present disclosure, the detection and identification of the region of interest can be performed by a trained network (e.g., a trained classifier, a machine learning system, a deep learning system, a trained neural network, etc.). Alternatively, other approaches can be utilized such as image segmentation algorithms, edge detection algorithms, etc. Areas in the image not identified as regions of interest can then be removed from the image, so as to crop the identified regions of interest from the remainder of the image. For the remaining region of interest, certain parameters associated with the beauty product can be extracted. For example, in an example of a content item displaying a lipstick, a color, gloss, opacity, etc. of the lipstick shown in the image can be extracted. Alternatively, for an eyeshadow, a color, an opacity, etc. associated with the eyeshadow can be extracted. Other parameters, such as, for example, a glitter, a glitter size, a glitter density, a shimmer, an intensity, etc. can also be extracted. For example, each pixel in the regions of interest can be processed to extract parameters such as gloss, red-green-blue (RGB) values, etc. Additionally, the extracted parameters can vary for each type of beauty product.

After the parameters have been extracted, they can be compared against stored parameter values associated with stored beauty products. Based on the comparison of the parameters extracted from the content with stored parameters, a corresponding beauty product that may produce the same or similar look/beauty aesthetic as shown in the content item can be identified. The identified beauty product can include, for example, the beauty product presented in the content item that was used to achieve the look presented in the content item. Alternatively and/or in addition, the identified beauty product may include beauty products that can provide the same, or a substantially similar, look/beauty aesthetic as that presented in the content item. Optionally, content system 110 can render the identified beauty products on a live-feed streaming video of any of users 101-1, 101-2, or 101-3 on client devices 102-1, 102-2, or 102-3 so that user 101-1, 101-2, or 101-3 can assess the appearance of the identified beauty products on his/her face in the live-feed streaming video. For example, content system 110 can receive, from any of client devices 102-1, 102-2, or 102-3, a streaming live-feed video of user 101-1, 101-2, or 101-3. Content system 110 can then render any of the identified beauty products on the streaming live-feed video of user 101-1, 101-2, or 101-3 on client device 102-1, 102-2, or 102-3 so that user 101-1, 101-2, or 101-3 can assess the appearance of the identified beauty products on his/her face in the live-feed streaming video.

Content system 110 can also include a data store which can store and maintain a corpus of additional content items 120 which can include additional content items 120-1, 120-2, 120-3, and 120-4 and can be provided to users 101-1, 101-2, and 101-3 via client devices 102-1, 102-2, and 102-3. For example, content system 110 can provide the additional content items 120-1, 120-2, 120-3, and 120-4 to users 101-1, 101-2, and 101-3 via client devices 102-1, 102-2, and 102-3 as recommended content items that may include looks/beauty aesthetics that may be similar, be related in certain aspects, be a contrasting look, be a recommended look, be an alternative look, etc. to the look/beauty aesthetic presented in the content item provided by user 101-1, 101-2, or 101-3. Similar to the content item that may be provided by a user, each additional content item 120-1, 120-2, 120-3, and 120-4 of the corpus of additional content items 120 can also include, for example, any content (e.g., images, videos, etc.) that may include an image having a visual representation of at least a portion of a body part (e.g., a face, a hand, toes, nails, hair, etc.) with a look/beauty aesthetic. The look/beauty aesthetic can be composed of the application of one or more beauty products and/or styles (e.g., lipstick, eyeshadow, mascara, eyeliner, foundation, concealer, powder, blush, eye pencil, nail polish, toe polish, hair dye, hair style, hair extensions, hair perm, etc.) which, when combined, can contribute to an overall beauty aesthetic. Further, as with the content item provided by user 101-1, 101-2, or 101-3, each additional content item 120-1, 120-2, 120-3, and 120-4 of the corpus of additional content items 120 can be or may already have been processed to extract certain parameters associated with the look/beauty aesthetic presented therein. For example, additional content items 120-1, 120-2, 120-3, and 120-4 can be processed to extract parameters (e.g., a color, a shape, an opacity, an amount, a glitter, a glitter size, a glitter density, a shape of application, a shimmer, an intensity, etc.) associated with areas of interest in each respective additional content item 120-1, 120-2, 120-3, and 120-4 to identify a corresponding beauty product (e.g., lipstick, eyeshadow, mascara, eyeliner, foundation, concealer, powder, blush, eye pencil, nail polish, toe polish, hair dye, hair style, hair extensions, hair perm, etc.) presented in each respective additional content item 120-1, 120-2, 120-3, and 120-4. The extracted parameters can be associated and stored with each respective additional content item 120-1, 120-2, 120-3, and 120-4.

In providing additional content items 120-1, 120-2, 120-3, and 120-4 to users 101-1, 101-2, or 101-3, the parameters extracted from the user provided content item can be compared against the parameters extracted from the additional content items 120-1, 120-2, 120-3, and 120-4. The comparison can be made to identify looks/beauty aesthetics that may be similar, be related in certain aspects, be a contrasting look, be a recommended look, be an alternative look, etc. to the look/beauty aesthetic presented in the content item provided by user 101-1, 101-2, or 101-3. The identified additional content items 120-1, 120-2, 120-3, and 120-4 can then be provided to users 101-1, 101-2, or 101-3 on client devices 102-1, 102-2, or 102-3. Further, the looks/beauty aesthetics presented in the additional content items 120-1, 120-2, 120-3, and 120-4 provided to users 101-1, 101-2, or 101-3 can also be rendered on a live-feed streaming video or a selfie of the user so that the user can assess the appearance of the beauty products on his/her face in the live-feed streaming video or the selfie.

Optionally, according to certain aspects of the present disclosure, the processing of the additional content items 120-1, 120-2, 120-3, and 120-4 can include identifying a dominant skin tone associated with the look/beauty aesthetic presented in each of the additional content items 120-1, 120-2, 120-3, and 120-4 and classifying each additional content item 120-1, 120-2, 120-3, and 120-4 by skin tone to facilitate filtering of the additional content items 120-1, 120-2, 120-3, and 120-4 based on a desired skin tone. According to certain implementations, each additional content item 120-1, 120-2, 120-3, and 120-4 can be classified into one of four different skin tone classes (e.g., light, medium-light, medium-dark, and dark). Alternatively, any number of classification classes can be utilized depending on the granularity of classification that is desired (e.g., 2 classes, 3 classes, 4 classes, 5 classes, 6 classes, 7 classes, 8 classes, 9 classes, 10 classes, etc.). In classifying each additional content item 120-1, 120-2, 120-3, and 120-4 by skin tone, threshold values can be determined for each class of skin tone being utilized. As described further herein, the threshold values can be based on color space values, and the color space values for each additional content item 120-1, 120-2, 120-3, and 120-4 can be compared to the thresholds to classify each additional content item 120-1, 120-2, 120-3, and 120-4 into one of the prescribed classes. According to certain aspects of the present disclosure, the threshold values for each class can be determined using a trained network (e.g., a trained classifier, a machine learning system, a deep learning system, a trained neural network, etc.).

In determining the skin tone, content system 110 can first identify the regions in each additional content item 120-1, 120-2, 120-3, and 120-4 that correspond to skin tone. Accordingly, for additional content items 120-1, 120-2, 120-3, and 120-4 that include a representation of a face, content system 110 can utilize a face detection algorithm to detect features, regions of interest, landmarks, etc. presented in each additional content item 120-1, 120-2, 120-3, and 120-4 to determine the pixels corresponding to the face shown in the additional content item 120-1, 120-2, 120-3, and 120-4. According to certain aspects of the present disclosure, the detection and identification of regions of interest can be performed by a trained network (e.g., a trained classifier, a machine learning system, a deep learning system, a trained neural network, etc.). Alternatively, other approaches can be utilized such as image segmentation algorithms, edge detection algorithms, etc. The remainder of the visual representation can be removed from the content item, so as to crop the identified regions of interest (e.g., the lips and the eyes).

Alternatively, in additional content items 120-1, 120-2, 120-3, and 120-4 that do not include a visual representation of a face, a hue, saturation, value (HSV) model can be applied to ascertain the pixels that may correspond to skin tone in the additional content item 120-1, 120-2, 120-3, and 120-4. For example, this may be used in images of hands, nails, toes, feet, etc. Optionally, prior to the detection of pixels corresponding to skin tone, pre-processing of the image can be performed (e.g., to correct for exposure, etc.) to compensate for over-exposed or under-exposed images. Then, once the pixels corresponding to skin tone have been identified (e.g., either by facial detection or application of an HSV model), the RGB value for each identified pixel can be determined. The RGB values for each pixel can then be used to determine a median RGB value or a clustering algorithm can be applied to obtain relevant RGB values for the skin tone regions of each additional content item 120-1, 120-2, 120-3, and 120-4. The RGB values can then be transformed into a color space, such as a lightness (L), A, B color space (LAB), where L can represent a lightness (e.g., on a scale from 0-100 with 0 corresponding to black and 100 corresponding to white), A can represent a red-green coloration, and B can represent a blue-yellow coloration. The LAB values for each additional content item 120-1, 120-2, 120-3, and 120-4 can then be utilized to classify each additional content item 120-1, 120-2, 120-3, and 120-4. For example, the classifications can be determined based on a lightness value in the LAB model, or a lightness value and the B value, which can be used to determine an individualized typology angle (ITA). The predetermined thresholds for each skin tone classification class can be based on a lightness value or an ITA value, and the lightness and/or ITA value for each additional content item 120-1, 120-2, 120-3, and 120-4 can be compared against the threshold values to classify each additional content item 120-1, 120-2, 120-3, and 120-4. The skin tone classification can then be associated and stored with each respective additional content item 120-1, 120-2, 120-3, and 120-4.

In view of the skin tone classifications, user 101-1, 101-2, or 101-3 can specify a skin tone, and only additional content items 120-1, 120-2, 120-3, and 120-4 having the skin tone specified by the user may be presented to the user. According to one aspect, a user's skin tone can be detected (in a manner similar to that described with respect to associating a skin tone with the additional content items) and only additional content items 120-1, 120-2, 120-3, and 120-4 having the detected skin tone may be presented to the user. Preferably, because of the potentially sensitive nature of this data with respect to a user, there may be times when the selection of skin tone by a user and/or detection of a user's skin tone should not be stored, saved, and/or otherwise retained by content system 110, so as to protect the privacy of users.

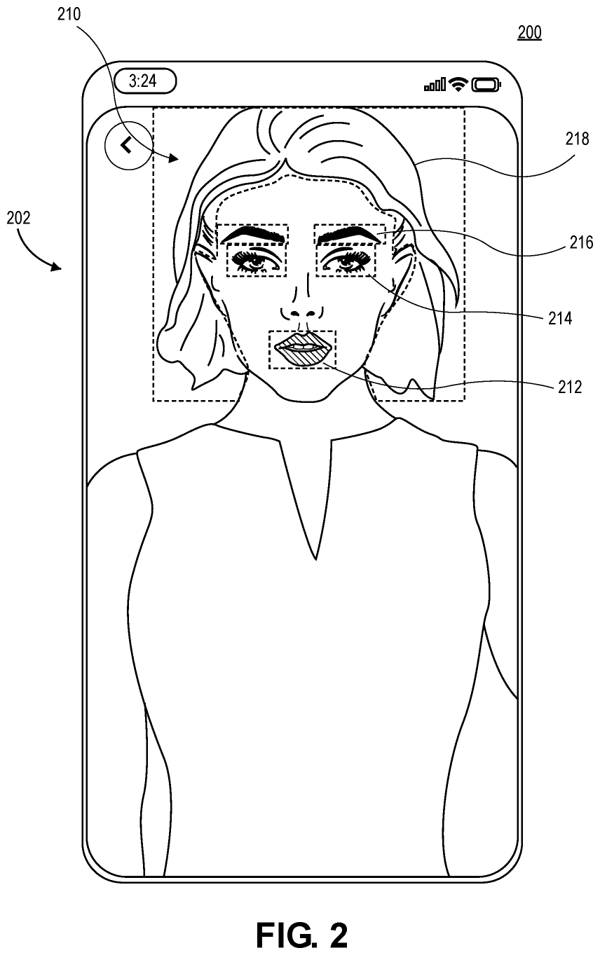

FIG. 2 illustrates an exemplary content item 200 represented on a client device (e.g., any of client devices 102-1, 102-2, or 102-3) according to embodiments of the present disclosure. As shown in FIG. 2, content item 200 can include image 202 of an overall look/beauty aesthetic 210. Overall look/beauty aesthetic 210 can include, for example, a first beauty product (e.g., lipstick) applied to the lips 212, a second beauty product (e.g., eyeshadow) applied to the eye regions 214, a third beauty product (e.g., eyebrow pencil) applied to the eyebrows 216, and a hair style (e.g., hair dye, perm, etc.) applied to the hair 218. According to other aspects, overall look/beauty aesthetic 210 can include any number of beauty products or styling features (e.g., lipstick, eyeshadow, mascara, eyeliner, foundation, concealer, powder, blush, eye pencil, nail polish, toe polish, hair dye, hair style, hair extensions, etc.) applied to any region or area of the face, or other body parts (e.g., hands, feet, fingernails, toenails, etc.). Content item 200 may represent a user provided content item of interest. For example, content item 200 may be an image generated using a camera of the client device (e.g., any of client devices 102-1, 102-2, or 102-3) being used by the user, an image from memory of a client device (e.g., client devices 102-1, 102-2, or 102-3) being used by the user, an image stored in a memory that is external to a client device (e.g., client devices 102-1, 102-2, or 102-3) being used by the user, an image provided by the system with which the user is interacting (e.g., content system 110), and/or an image from another source or location.

According to certain exemplary embodiments, content item 200 can be provided by a user as a user provided content item of interest. According to embodiments of the present disclosure, a user provided content item can be processed to extract parameters associated with the overall look/beauty aesthetic shown in content item 200. For example, each of lips 212, eye regions 214, eyebrows 216, and hair 218 can be detected and isolated as a region of interest. The detection and identification of these regions of interest (e.g., lips 212, eye regions 214, eyebrows 216, and hair 218) can be obtained by utilizing facial detection algorithms. Alternatively and/or in addition, the detection and identification of the regions of interest can be obtained by utilizing image segmentation algorithms, edge detection algorithms, etc. or a trained network (e.g., a trained classifier, a machine learning system, a deep learning system, a trained neural network, etc.). According to aspects of the present disclosure, content item 200 can include an image of another body part (e.g., hands, feet, fingernails, toenails, etc.) and/or a portion of a body part (e.g., a portion of a face, etc.).

After each region of interest has been isolated, certain parameters associated with the beauty product applied in each respective region of interest can be extracted. For example, for lips 212, a color, a gloss, an opacity, etc. of the lipstick applied to lips 212 in image 202 of content item 200 can be extracted. For eye region 214, a shape of application, a color, an opacity, a shimmer, etc. of the eyeshadow applied to eye region 214 in image 202 of content item 200 can be extracted. For eyebrows 216, a color, an opacity, a shimmer, etc. of the eyebrow pencil applied to eyebrows 216 in image 202 of content item 200 can be extracted. For hair 218, a color, highlights, a perm, a shimmer, etc. of the hairstyle applied to hair 218 appearing in image 202 of content item 200 can be extracted. For example, in extracting the various parameters, each pixel in each of the regions of interest can be processed to extract parameters such as gloss, red-green-blue (RGB) values, etc. Other parameters, such as, a glitter, a glitter size, a glitter density, a shape of application, a shimmer, an intensity, etc. can also be extracted. Additionally, the extracted parameters can vary for different regions of interest and/or for each type of beauty product that may be applied in the image shown in the content item.

After the parameters have been extracted for each region of interest, a user may opt to view a rendering of one or more of the beauty products applied in the image to achieve look/beauty aesthetics presented in content item 200 on a content associated with him/her self (e.g., a live-feed video of him/herself, a selfie, etc.). The user can use a camera associated with a client device (e.g., client device 102-1, 102-2, or 102-3) to capture a streaming live-feed video of him/herself, capture a selfie, or provide an existing image, and the parameters extracted for each selected beauty product (e.g., the lipstick applied on lips 212, the eyeshadow applied on eye regions 214, the eyebrow pencil applied on eyebrows 216, and/or the hair style applied to hair 218) can be used to generate a rendering of the beauty product onto the user's face in the content item. This can allow a user to see how the selected looks/beauty aesthetics may appear on the user. For example, the user can select to have the lipstick applied to lips 212 in content item 200 rendered on him/herself in content item of him/herself.

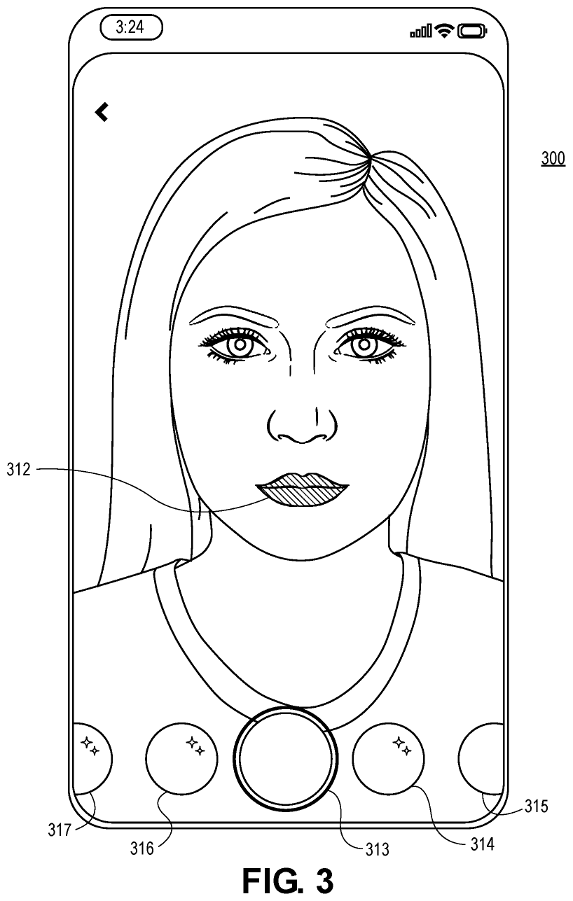

FIG. 3 is an illustration of a frame of a streaming live-feed video 300 according to embodiments of the present disclosure which includes a rendering of a selected beauty product. In FIG. 3, streaming live-feed video 300 shows a rendering of the lipstick from lips 212 in content item 200 applied to lips 312 of the user shown in streaming live-feed video 300. Alternatively and/or in addition, one or more of the other products shown in content item 200 (e.g., eye shadow applied to eye regions 214, eye pencil applied to eyebrows 216, and/or hair style applied to hair 218, etc.) as part of the look/beauty aesthetic presented in content item 200 can be generated and rendered onto the face of the user shown in streaming live-feed video 300. Additionally, other content item types, such as a selfie, or an existing image, can be used to render the beauty product so that the user can evaluate the appearance of the beauty product on the face of the user. Further, facial detection can be performed on the image presented in streaming live-feed video 300 such that the rendering of the lipstick on the face of the user tracks movements of the user so that the rendering of the lipstick remains on lips 312 of the user in streaming live-feed video 300 regardless of whether the user may move as the streamed video is being captured and presented. This can allow the user the assess the appearance of the beauty product from various angles and perspectives. Optionally, aspects of the present disclosure may also provide, based on the extracted parameters associated with the beauty product being rendered, options for customizing the beauty product being rendered in the streaming live-feed video. As shown in FIG. 3, customization options 313, 314, 315, 316, and 317 may be presented as the lipstick is rendered on lips 312 in streaming live-feed video 300. For example, customization options 313, 314, 315, 316, and 317 can include related, complementary, and/or alternative colors, gloss, shimmer, opacity, etc.

Alternatively and/or in addition to generating a rendering of the selected beauty products based on the extracted parameters, embodiments of the present disclosure can also identify specific beauty products that may create the same or a similar look/beauty aesthetic to the beauty products applied in the user supplied content item so that they can be provided as a recommendation to the user. Continuing the exemplary embodiment where a user may provide and/or identify content item 200 as a content item of interest. After the parameters have been extracted for each region of interest, one or more beauty products may be identified that may create the same or similar look/beauty aesthetic as the beauty product shown in content item 200. For example, the parameters extracted for the lipstick applied on lips 212 can be used to identify one or more corresponding lipsticks that may recreate the look/beauty aesthetic, or a similar such look/beauty aesthetic, to the lipstick applied on lips 212 and presented in content item 200. Similarly, the parameters extracted for the eyeshadow applied on eye regions 214, the eyebrow pencil applied on eyebrows 216, and/or the hair style applied to hair 218 can be used to identify one or more corresponding eyeshadows, eyebrow pencils, and/or hair styles, respectively, that may recreate the look/beauty aesthetic, or a similar such look/beauty aesthetic, to the eyeshadow applied on eye regions 214, the eyebrow pencil applied on eyebrows 216, and/or the hair style applied to hair 218, respectively, and presented in content item 200.

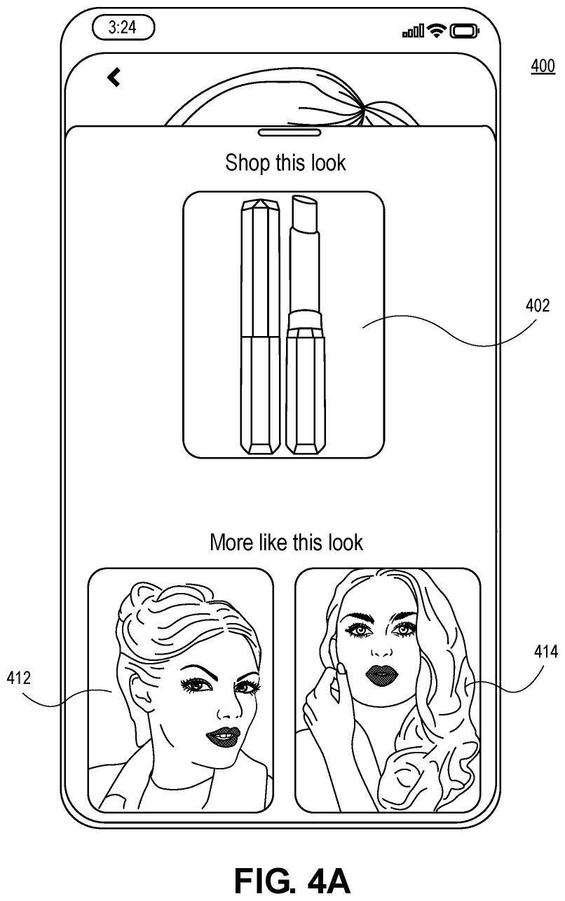

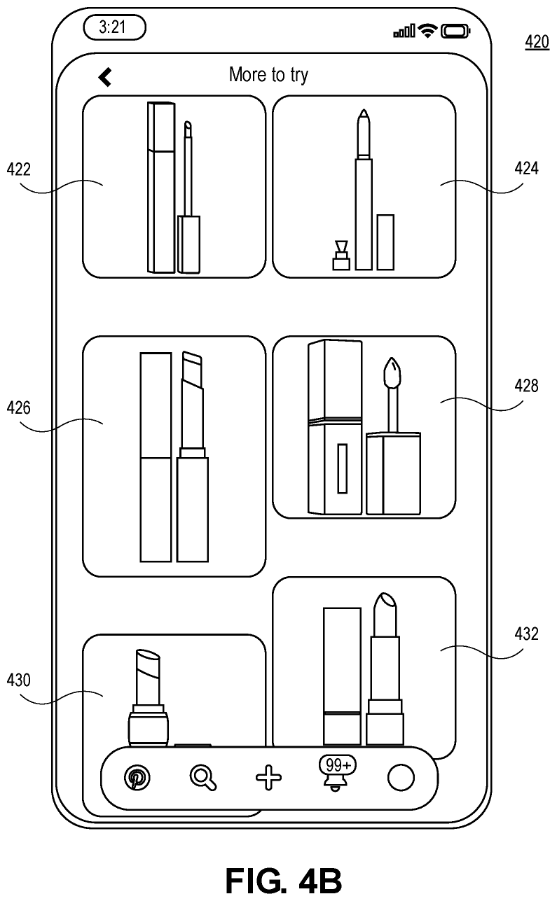

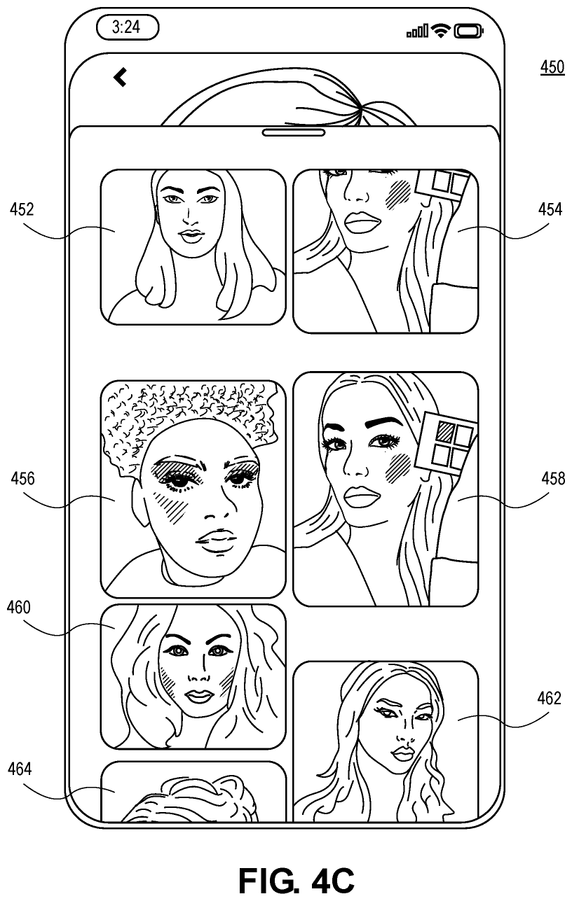

FIGS. 4A and 4B are illustrations of exemplary presentations 400 and 420 of an identification and/or recommendation of corresponding lipsticks according to embodiments of the present disclosure. As shown in FIG. 4A, lipstick 402 may have been identified as a lipstick that may produce a look/beauty aesthetic similar to that which may be created by the lipstick applied to lips 212 in content item 200. For example, parameters such as color, gloss, opacity, etc. may have been extracted in connection with the lipstick applied to lips 212 in content item 200 and compared against stored parameters associated with stored lipsticks. Accordingly, the comparison can then identify lipsticks with similar parameters that may produce the same or similar look/beauty aesthetic to the look/beauty aesthetic produced by the lipstick applied to lips 212 in content item 200. Alternatively, the extracted parameters may be compared with stored parameters associated with stored lipsticks to identify related, complementary, alternative, contrasting, etc. looks/beauty aesthetics to the look/beauty aesthetic produced by the lipstick applied to lips 212 in content item 200. As shown in FIGS. 4A and 4B, the identified lipsticks 402, 422, 424, 426, 428, 430, and 432 may be presented on a client device to the user. Similar to the ability to view a rendering of a beauty product extracted from content item 200, a user can select any of lipsticks 402, 422, 424, 426, 428, 430, and 432 to view a rendering of any of lipsticks 402, 422, 424, 426, 428, 430, and 432 on a live-feed video of him/herself to allow the user to determine how the respective lipstick may appear on the user. Although the identification and rendering of certain beauty products has been described primarily with respect to lipsticks, this can be performed for any looks/beauty aesthetics, and/or beauty products, such as, for example, lipstick, eyeshadow, mascara, eyeliner, foundation, concealer, powder, blush, eye pencil, nail polish, toe polish, hair dye, hair style, hair extensions, etc.

In addition to identifying individual beauty products, embodiments of the present disclosure can also identify additional content items (e.g., from additional content items 120-1, 120-2, 120-3, and 120-4) having an image with an overall look/beauty aesthetic based on the user provided content item 200 to provide as a recommendation to the user. According to certain exemplary embodiments, a plurality of additional content items (e.g., additional content items 120-1, 120-2, 120-3, and 120-4) can be stored and maintained in a datastore (e.g., as a corpus of additional content items 120). Similar to the processing of user provided content item 200, each of the additional content items can be processed to extract certain parameters associated with the look/beauty aesthetic and/or beauty products presented in each additional content item. For example, each additional content item can be processed to detect and isolate regions of interest (e.g., lips, eye regions, cheeks, hair, fingernails, toenails, etc.). The detection and identification of these regions of interest can be obtained by utilizing facial detection algorithms. Alternatively and/or in addition, the detection and identification of the regions of interest can be obtained by utilizing image segmentation algorithms, edge detection algorithms, etc. or a trained network (e.g., a trained classifier, a machine learning system, a deep learning system, a trained neural network, etc.).

After each region of interest has been isolated, certain parameters associated with the beauty product(s) applied in each respective region of interest can be extracted. For example, a color, a gloss, an opacity, a shape of application, a color, an opacity, a shimmer, highlights, a perm, an amount of application, a glitter, a glitter size, a glitter density, an intensity, etc. can be extracted from the various regions of interest depending on the type of beauty product that may have been applied in each respective region of interest. To extract the various parameters, each pixel in each of the regions of interest can be processed to extract parameters such as gloss, red-green-blue (RGB) values, etc. These extracted parameters can be associated and stored with each respective additional content item. Accordingly, similar to the identification of an individual beauty product, the parameters extracted from content item 200 can be compared against the stored parameters associated with each respective additional content item. Accordingly, the comparison can then identify additional content items with similar parameters that may produce the same or similar overall look/beauty aesthetic to the look/beauty aesthetic presented in content item 200. Alternatively, the extracted parameters may be compared with stored parameters associated with each respective additional content item to identify related, complementary, alternative, contrasting, etc. looks/beauty aesthetics to the look/beauty aesthetic presented in content item 200. FIGS. 4A and 4C are illustrations of exemplary presentations 400 and 450 of an identification and/or recommendation of corresponding lipsticks according to embodiments of the present disclosure. As shown in FIGS. 4A and 4C, the identified additional content items 412, 414, 452, 454, 456, 458, 460, 462, and 464 may be presented on a client device to the user. As shown in FIGS. 4A and 4C, each additional content item 412, 414, 452, 454, 456, 458, 460, 462, and 464 may include an image presenting a certain look/beauty aesthetic. Similar to the ability to view a rendering of a beauty product extracted from content item 200, a user can select any of additional content items 412, 414, 452, 454, 456, 458, 460, 462, and 464 to view a rendering of any of the beauty products applied in any of the additional content items 412, 414, 452, 454, 456, 458, 460, 462, and 464 on a content item associated with him/herself to allow the user to determine how the respective beauty product may appear on the user.

Optionally, according to certain aspects of the present disclosure, the processing of the additional content items can also include identifying a dominant skin tone associated with the look/beauty aesthetic presented in each of the additional content items and classifying each additional content item by skin tone to facilitate filtering of the additional content items based on a desired skin tone. According to certain implementations, each additional content item can be classified into one of four different skin tone classes (e.g., light, medium-light, medium-dark, and dark). Alternatively, any number of classification classes can be utilized depending on the granularity of classification that is desired (e.g., 2 classes, 3 classes, 4 classes, 5 classes, 6 classes, 7 classes, 8 classes, 9 classes, 10 classes, etc.). In classifying each additional content item by skin tone, threshold values can be determined for each class of skin tone being utilized. As described further herein, the threshold values can be based on color space values, and the color space values for each additional content item can be compared to the thresholds to classify each additional content item into one of the prescribed classes. According to certain aspects of the present disclosure, the threshold values for each class can be determined using a trained network (e.g., a trained classifier, a machine learning system, a deep learning system, a trained neural network, etc.).

In determining the skin tone, the regions in each additional content item that correspond to skin tone can first be identified. Accordingly, for the additional content items that include a representation of a face, a face detection algorithm can be utilized to detect features, regions of interest, landmarks, etc. presented in each additional content item to determine the pixels corresponding to the face presented in the respective additional content item. According to certain aspects of the present disclosure, the detection and identification of regions of interest can be performed by a trained network (e.g., a trained classifier, a machine learning system, a deep learning system, a trained neural network, etc.). Alternatively, other approaches such as image segmentation algorithms, edge detection algorithms, etc. can also be utilized.

Alternatively and/or in addition, additional content items that do not include a visual representation of an HSV model can be applied to ascertain the pixels that may correspond to skin tone in the respective additional content item. For example, this may be used in images of hands, nails, toes, feet, etc. Optionally, prior to the detection of pixels corresponding to skin tone (e.g., through facial detection or application of an HSV model), pre-processing of the image can be performed (e.g., to correct for exposure, etc.) to compensate for over-exposed or under-exposed images. After the pixels corresponding to skin tone have been identified (e.g., either by facial detection or application of an HSV model), the RGB value for each identified pixel can be determined. According to certain aspects of the present disclosure, the RGB values for each pixel can then be used to determine a median RGB value for the skin tone regions of each additional content item. Alternatively, clustering algorithms can be applied to extract relevant RGB values. The RGB values can then be transformed into a color space, such as a lightness (L), A, B color space (LAB), where L can represent a lightness value (e.g., on a scale from 0-100 with 0 corresponding to black and 100 corresponding to white), A can represent a red-green coloration, and B can represent a blue-yellow coloration. The LAB values for each additional content item can then be utilized to classify each additional content item. For example, the classifications can be determined based on a lightness value in the LAB model, or a lightness value and the B value, which can be used to determine an ITA associated with each additional content item. The predetermined thresholds for each skin tone classification class can be based on a lightness value or an ITA value, and the lightness and/or ITA value for each additional content item can be compared against the threshold values to classify each additional content item. The skin tone classification can then be associated and stored with each respective additional content item.

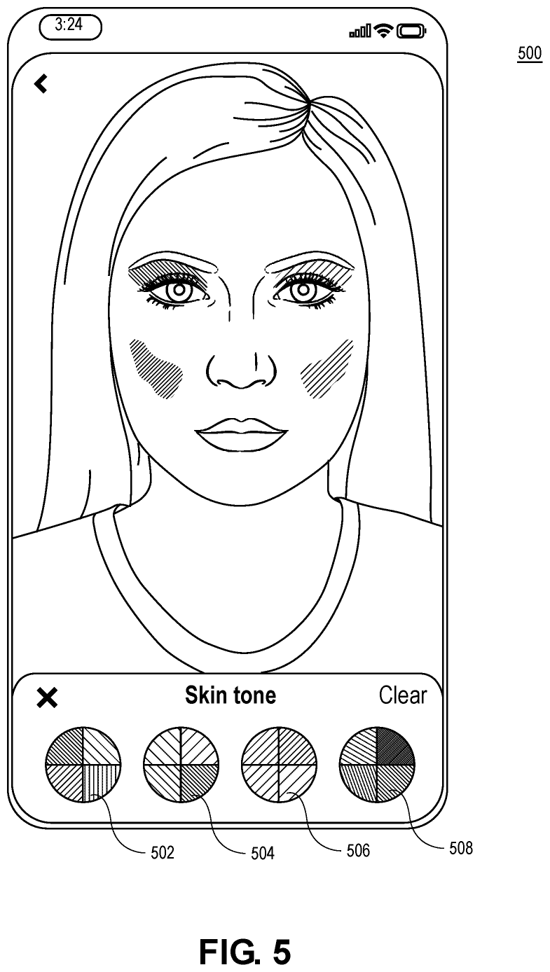

According to embodiments of the present disclosure, a user can specify a target skin tone in connection with any additional content items that may be provided to the user as an identified and/or recommended look/beauty aesthetic, such that additional content items only classified with the skin tone specified by the user are presented to the user. FIG. 5 is an illustration of an exemplary presentation 500 of an interface through which a user can specify a target skin tone for which he/she desires to see additional looks/beauty aesthetics. As shown in FIG. 5, a user may select any target skin tones 502, 504, 506, or 508. According to other embodiments of the present disclosure, the skin tone of the user can be detected in a streaming live-feed video and/or selfie of the user and be used as the target skin tone by which to filter the additional content items. Upon selection or determination of a target skin tone, the identified additional content items can be filtered to only include the additional content items having the same classification as the target skin tone, and those additional content items may be presented to the user as identified and/or recommended looks/beauty aesthetics. Preferably, because of the potentially sensitive nature of this data with respect to a user, there may be times when the selection of skin tone by a user and/or detection of a user's skin tone should not be stored, saved, and/or otherwise retained by content system 110, so as to protect the privacy of users.

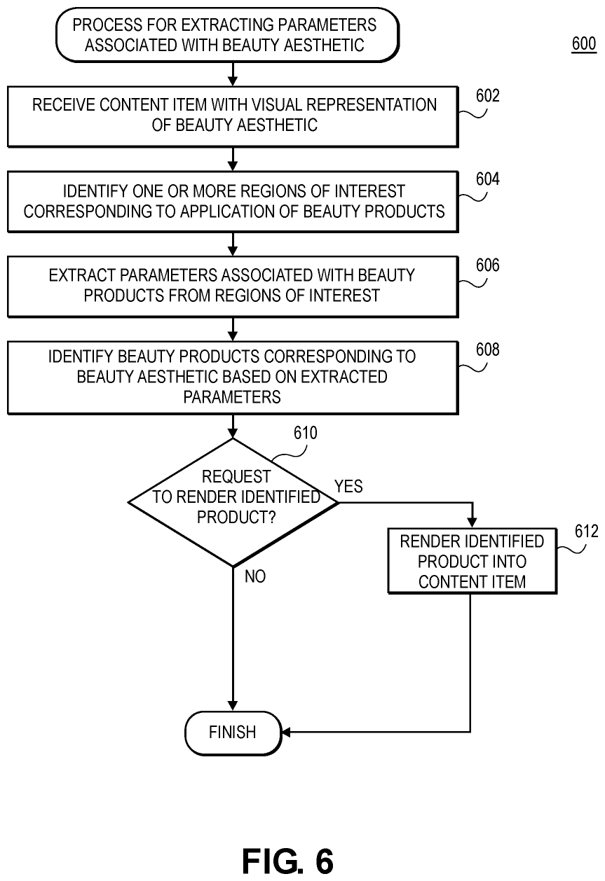

FIG. 6 illustrates a flow diagram of an exemplary process 600 for extracting parameters associated with a beauty aesthetic. In step 602, a content item (e.g., user provided content item 200) having an image with a visual representation of a beauty aesthetic can be provided. Next, regions of interest corresponding to the application of a beauty product (e.g., lips 212, eye regions 214, eyebrows 216, hair 218) can be identified, as in step 604. The detection and identification of these regions of interest (e.g., lips 212, eye regions 214, eyebrows 216, and hair 218) can be obtained by utilizing facial detection algorithms, image segmentation algorithms, edge detection algorithms, etc. or a trained network (e.g., a trained classifier, a machine learning system, a deep learning system, a trained neural network, etc.). After each region of interest has been isolated, certain parameters associated with the beauty product applied in each respective region of interest can be extracted, as in step 606. For example, a color, a glitter, a glitter size, a glitter density, a shape of application, a shimmer, an intensity, a gloss, an opacity, highlights, a perm, etc. can be extracted. For example, in extracting the various parameters, each pixel in each of the regions of interest can be processed to extract parameters such as gloss, red-green-blue (RGB) values, etc. In step 608, beauty products corresponding to the beauty products applied in the regions of interest can be identified based on the extracted parameters. The identified beauty products can include beauty products that may produce the same or similar look/beauty aesthetic to the look/beauty aesthetic produced by the beauty product applied in the region of interest in the content item. Alternatively, the identified beauty products can be beauty products that may produce looks/beauty aesthetics that are related, complementary, alternative, contrasting, etc. looks/beauty aesthetics to the look/beauty aesthetic produced by the beauty products in the content item. The corresponding beauty products may be identified by performing a comparison of the extracted parameters with parameters that are associated and stored with stored beauty products. In step 610, it can be determined whether the user desires to render the identified product. For example, a user may desire to render an identified product onto a content item associated with him/herself (e.g., a streaming live-feed video of him/herself, a selfie, etc.) to assess how the identified beauty product would look on the user. In the event that the user desires to render the identified product, the product can be rendered into the content item (e.g., streaming live-feed video, selfie, etc.) (step 612).

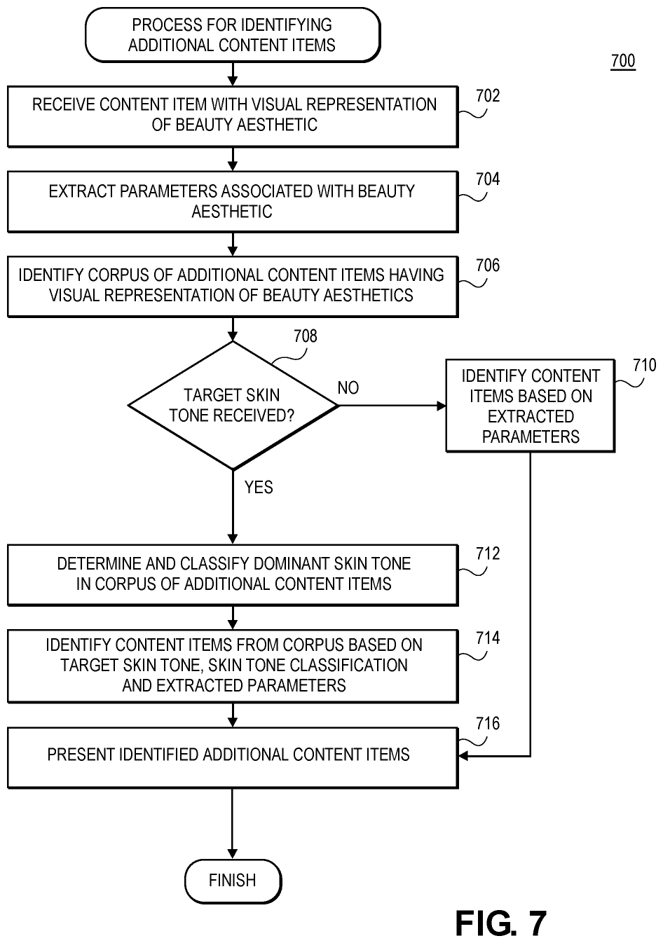

FIG. 7 illustrates a flow diagram of an exemplary process 700 for identifying additional content items (e.g., additional content items 412, 414, 452, 454, 456, 458, 460, 462, and 464 from additional content items 120-1, 120-2, 120-3, and 120-4). As shown in FIG. 7, in step 702, a content item (e.g., user provided content item 200) having an image with a visual representation of a beauty aesthetic is received. Next, parameters associated with the beauty aesthetic can be extracted in step 704. This can include, for example, process 600 for extracting parameters associated with a beauty aesthetic. In step 706, a corpus of additional content items (e.g., corpus of additional content items 120) having a visual representation of beauty aesthetics can be identified. If a target skin tone has been received (e.g., from a user), the corpus of additional content items can be processed to determine and classify the dominant skin tone present in each additional content item, as in step 712. Then, the additional content items can be identified based on the target skin tone, the extracted parameters, and the skin tone classification of the additional content items, as in step 714. Alternatively, if no target skin tone was received, the additional content items can be identified based on the extracted parameters (step 710). For example, similar to the identification of an individual beauty product, the parameters extracted from the content item can be compared against the stored parameters associated with each respective additional content item. Accordingly, the comparison can then identify additional content items with similar parameters that may produce the same or similar overall look/beauty aesthetic to the look/beauty aesthetic presented in the content item. Alternatively, the extracted parameters may be compared with stored parameters associated with each respective additional content item to identify related, complementary, alternative, contrasting, etc. looks/beauty aesthetics to the look/beauty aesthetic presented in content item. Next, the identified additional content items can be provided to the user in step 716.

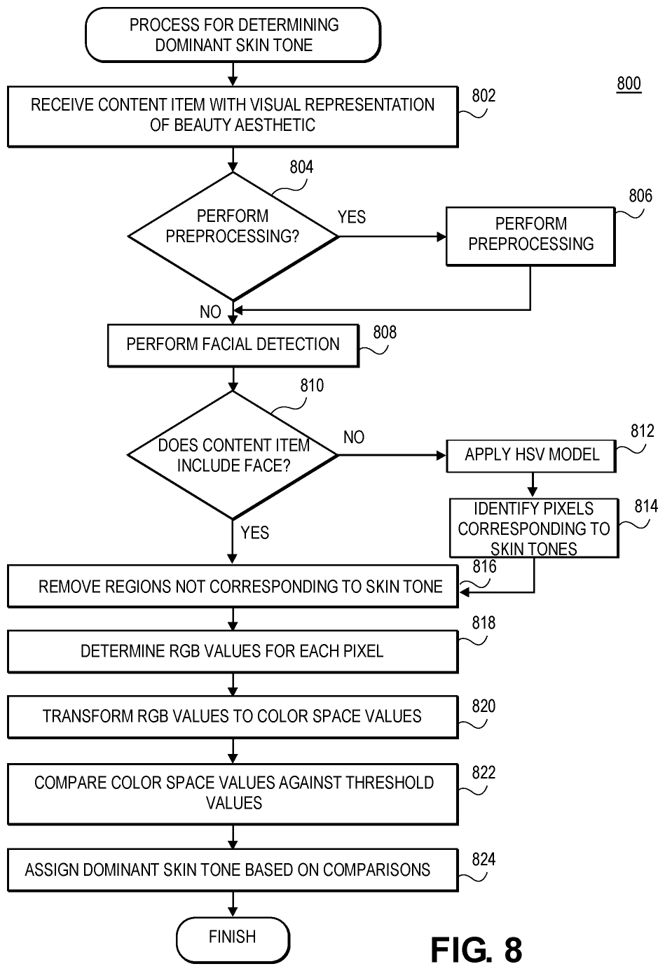

FIG. 8 illustrates a flow diagram of an exemplary process 800 for determining a dominant skin tone associated with a content item. In step 802, a content item with a visual representation of a beauty aesthetic can be received. This can include, for example, a user provided content item of interest (e.g., content item 200) or a stored additional content item (e.g., additional content item 120-1, 120-2, 120-3, and 120-4). In step 804 it is determined whether preprocessing is to be performed, and, if preprocessing is to be performed, it is performed in step 806. This can include, for example, correcting for exposure in the received content item. Next, facial detection algorithms can be performed (step 808) and it can be determined whether the content item includes a visual representation of a face, as in step 810. This can include, for example, utilizing a face detection algorithm to detect features, regions of interest, landmarks, etc. presented in the content item to determine the pixels corresponding to the face presented in the content item. According to certain aspects of the present disclosure, the detection and identification of regions of interest can be performed by a trained network (e.g., a trained classifier, a machine learning system, a deep learning system, a trained neural network, etc.). Alternatively, other approaches such as image segmentation algorithms, edge detection algorithms, etc. can also be utilized. If the content item does not include an image of a face, an HSV model can be applied (step 812) to ascertain the pixels that may correspond to skin tone in the content item (step 814). For example, this may be used in images of hands, nails, toes, feet, etc. In step 816, the regions not corresponding to skin tone can be removed. In the remaining image, the RGB values can then be determined for each pixel, as in step 818. According to certain aspects of the present disclosure, median RGB values can be determined and/or a clustering algorithm can be applied to obtain relevant RGB values. In step 820, the RGB values can then be transformed into color space values. For example the RGB value can be transformed to a lightness (L), A, B color space (LAB), where L can represent a lightness value (e.g., on a scale from 0-100 with 0 corresponding to black and 100 corresponding to white), A can represent a red-green coloration, and B can represent a blue-yellow coloration. In step 822, the color space values can be compared against threshold values to determine a classification and in step 824, the dominant skin tone can be assigned to the content item based on the comparisons with the thresholds. For example, the classifications can be determined based on a lightness value in the LAB model, or a lightness value and the B value, which can be used to determine an ITA associated with each additional content item. The predetermined thresholds for each skin tone classification class can be based on a lightness value or an ITA value, and the lightness and/or ITA value for each additional content item can be compared against the threshold values to classify each additional content item. The skin tone classification can then be associated and stored with each respective additional content item.

Regarding the processes 600, 700, and 800 described above with respect to FIGS. 6 through 8, as well as other routines and/or processes described or suggested herein, while these routines/processes are expressed in regard to discrete steps, these steps should be viewed as being logical in nature and may or may not correspond to any specific actual and/or discrete execution steps of a given implementation. Also, the order in which these steps are presented in the various routines and processes, unless otherwise indicated, should not be construed as the only or best order in which the steps may be carried out. Moreover, in some instances, some of these steps may be combined and/or omitted. Those skilled in the art will recognize that the logical presentation of steps is sufficiently instructive to carry out aspects of the claimed subject matter irrespective of any particular development or coding language in which the logical instructions/steps are encoded.

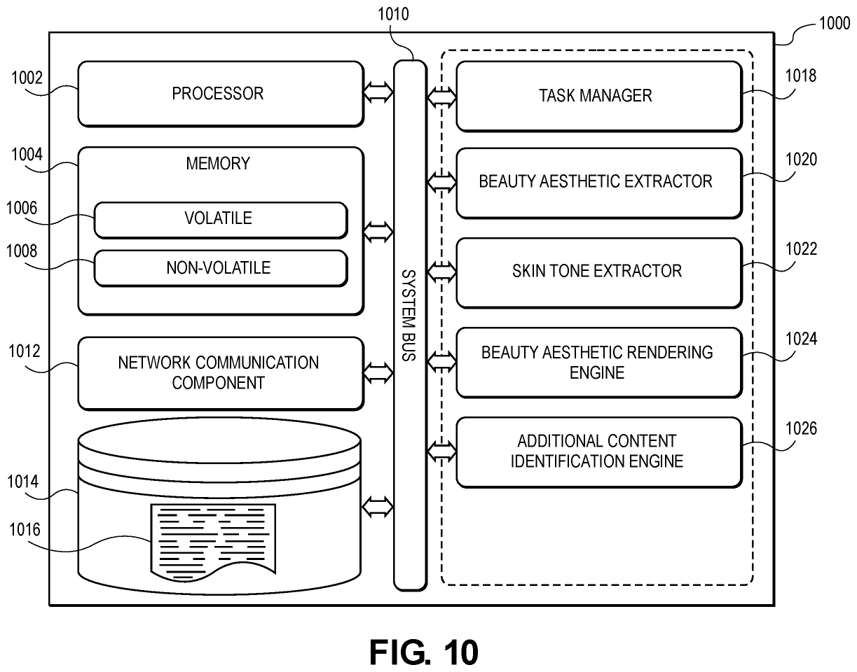

Of course, while these routines and/or processes include various novel features of the disclosed subject matter, other steps (not listed) may also be included and carried out in the execution of the subject matter set forth in these routines, some of which have been suggested above. Those skilled in the art will appreciate that the logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computing device described in regard FIG. 10 below. Additionally, in various implementations, all or some of the various routines may also be embodied in executable hardware modules including, but not limited to, systems on chips (SoC's), codecs, specially designed processors and/or logic circuits, and the like.

As suggested above, these routines and/or processes are typically embodied within executable code blocks and/or modules comprising routines, functions, looping structures, selectors and switches such as if-then and if-then-else statements, assignments, arithmetic computations, and the like that, in execution, configure a computing device to operate in accordance with the routines/processes. However, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied within applications (also referred to as computer programs), apps (small, generally single or narrow purposed applications), and/or methods, these aspects may also be embodied as computer executable instructions stored by computer readable media, also referred to as computer readable storage media, which are articles of manufacture. As those skilled in the art will recognize, computer readable media can host, store and/or reproduce computer executable instructions and data for later retrieval and/or execution. When the computer executable instructions that are hosted or stored on the computer readable storage devices are executed by a processor of a computing device, the execution thereof causes, configures and/or adapts the executing computing device to carry out various steps, methods and/or functionality, including those steps, methods, and routines described above in regard to the various illustrated implementations. Examples of computer readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random-access memory (RAM), read-only memory (ROM), memory cards, thumb drives, and the like; cloud storage (i.e., an online storage service); and the like. While computer readable media may reproduce and/or cause to deliver the computer executable instructions and data to a computing device for execution by one or more processors via various transmission means and mediums, including carrier waves and/or propagated signals, for purposes of this disclosure, computer readable media expressly excludes carrier waves and/or propagated signals.

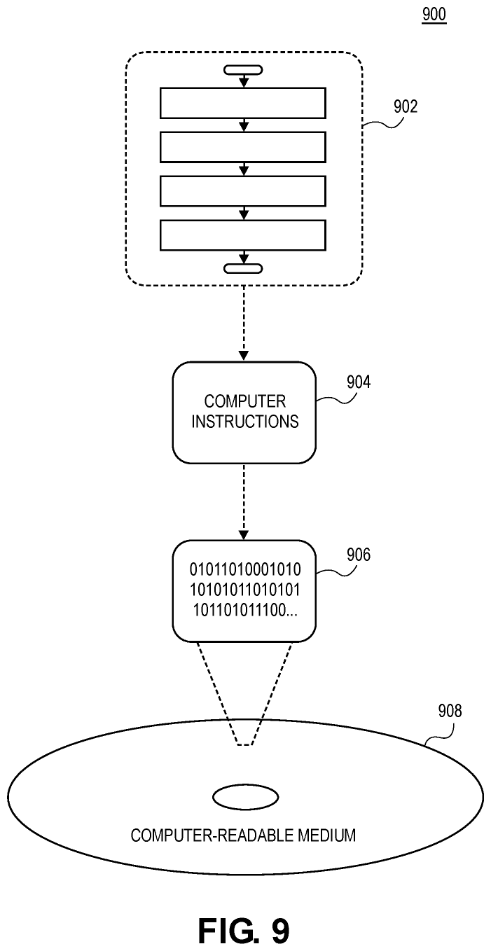

Regarding computer readable media, FIG. 9 is a block diagram illustrating an exemplary computer readable medium 900 encoded with instructions, as described in regard to processes 600, 700, and 800 of FIGS. 6 through 8, respectively. More particularly, the implementation can include a computer-readable medium 908 (e.g., a CD-R, DVD-R or a platter of a hard disk drive), on which is encoded computer-readable data 906. This computer-readable data 906 in turn can include a set of computer instructions 904 configured to operate according to one or more of the principles set forth herein. In one such implementation 902, the processor-executable instructions 904 may be configured to perform a method, such as at least some of exemplary processes 600, 700, and 800, for example. In another such implementation, the processor-executable instructions 904 may be configured to implement a system on a computing device, such as at least some of the exemplary, executable components of computing device 1000 of FIG. 10, as described below. Many such computer readable media may be devised, by those of ordinary skill in the art, which are configured to operate in accordance with the implementations presented herein.

FIG. 10 is a block diagram illustrating an exemplary computing system 1000 (or computing device) suitably configured for implementing the described implementations. Computing system 1000 typically can include one or more processors (or processing units), such as processor 1002, and further includes at least one memory 1004. The processor 1002 and memory 1004, as well as other components of the computing system, are interconnected by way of a system bus 1010.

As will be appreciated by those skilled in the art, the memory 1004 typically (but not always) includes both volatile memory 1006 and non-volatile memory 1008. Volatile memory 1006 retains or stores information so long as the memory is supplied with power. In contrast, non-volatile memory 1008 is capable of storing (or persisting) information even when a power supply is not available. Generally speaking, RAM and CPU cache memory are examples of volatile memory 1006 whereas ROM, solid-state memory devices, memory storage devices, and/or memory cards are examples of non-volatile memory 1008.

As will be further appreciated by those skilled in the art, the processor 1002 executes instructions retrieved from the memory 1004, from computer readable media, such as computer readable media 908 of FIG. 9, and/or other executable components in carrying out the various described implementations. The processor 1002 may be comprised of any of a number of available processors such as single-processor, multi-processor, single-core units, and multi-core units, which are well known in the art.

Further still, the illustrated computing system 1000 typically also includes a network communication interface 1012 for interconnecting this computing system with other devices, computers and/or services over a computer network, such as network 108 of FIG. 1. The network communication interface 1012, sometimes referred to as a network interface card or NIC, communicates over a network using one or more communication protocols via a physical/tangible (e.g., wired, optical fiber, etc.) connection, a wireless connection such as WiFi or Bluetooth communication protocols, NFC, or a combination thereof. As will be readily appreciated by those skilled in the art, a network communication interface, such as network communication component 1012, is typically comprised of hardware and/or firmware components (and may also include or comprise executable software components) that transmit and receive digital and/or analog signals over a transmission medium (i.e., the network).

The exemplary computing system 1000 further includes an executable task manager 1018. As described, task manager 1018 can include beauty aesthetic extractor 1020, skin tone extractor 1022, beauty aesthetic rendering engine 1024, and additional content identification engine 1026. Task manager 1018 may be operable to deliver content to devices, receive information from devices, and/or perform one or more of the routines 600, 700, and/or 800. In some implementations, the content system may provide additional content items 1016 from a digital content items store 1014 for presentation on a user device. As discussed above, the content system may also determine which potential advertisements to provide for presentation to a user on a user device.

It should be understood that, unless otherwise explicitly or implicitly indicated herein, any of the features, characteristics, alternatives or modifications described regarding a particular implementation herein may also be applied, used, or incorporated with any other implementation described herein, and that the drawings and detailed description of the present disclosure are intended to cover all modifications, equivalents and alternatives to the various implementations as defined by the appended claims. Moreover, with respect to the one or more methods or processes of the present disclosure described herein, including but not limited to the flow charts shown in FIGS. 6-8, orders in which such methods or processes are presented are not intended to be construed as any limitation on the claimed inventions, and any number of the method or process steps or boxes described herein can be combined in any order and/or in parallel to implement the methods or processes described herein. Also, the drawings herein are not drawn to scale.

Conditional language, such as, among others, “can,” “could,” “might,” or “may,” unless specifically stated otherwise, or otherwise understood within the context as used, is generally intended to convey in a permissive manner that certain implementations could include, or have the potential to include, but do not mandate or require, certain features, elements and/or steps. In a similar manner, terms such as “include,” “including” and “includes” are generally intended to mean “including, but not limited to.” Thus, such conditional language is not generally intended to imply that features, elements and/or steps are in any way required for one or more implementations or that one or more implementations necessarily include logic for deciding, with or without user input or prompting, whether these features, elements and/or steps are included or are to be performed in any particular implementation.

The elements of a method, process, or algorithm described in connection with the implementations disclosed herein can be embodied directly in hardware, in a software module stored in one or more memory devices and executed by one or more processors, or in a combination of the two. A software module can reside in RAM, flash memory, ROM, EPROM, EEPROM, registers, a hard disk, a removable disk, a CD-ROM, a DVD-ROM or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Disjunctive language such as the phrase “at least one of X, Y, or Z,” or “at least one of X, Y and Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain implementations require at least one of X, at least one of Y, or at least one of Z to each be present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

Language of degree used herein, such as the terms “about,” “approximately,” “generally,” “nearly” or “substantially” as used herein, represent a value, amount, or characteristic close to the stated value, amount, or characteristic that still performs a desired function or achieves a desired result. For example, the terms “about,” “approximately,” “generally,” “nearly” or “substantially” may refer to an amount that is within less than 10% of, within less than 5% of, within less than 1% of, within less than 0.1% of, and within less than 0.01% of the stated amount.

Although the invention has been described and illustrated with respect to illustrative implementations thereof, the foregoing and various other additions and omissions may be made therein and thereto without departing from the spirit and scope of the present disclosure.

What is claimed is:

1. A computer-implemented method, comprising:
obtaining a query for a plurality of content items;
causing, via a first user interface, a plurality of target skin tones to be presented on a client device associated with a user;
obtaining, via an interaction with the first user interface, a first target skin tone from the plurality of target skin tones;
processing, using a trained machine learning model, each of a first plurality of content items stored and maintained in a data store to determine a respective dominant skin tone associated with each of the first plurality of content items, the respective dominant skin tone for each of the first plurality of content items including one of the plurality of target skin tones;
determining, based at least in part on the first target skin tone, a second plurality of content items from the first plurality of content items, wherein the respective dominant skin tone associated with each of the second plurality of content items includes the first target skin tone; and
causing, via a second user interface, the second plurality of content items to be presented on the client device as responsive to the query.

2. The computer-implemented method of claim 1, wherein processing each of the first plurality of content items includes:
determining, using the trained machine learning model and for each of the first plurality of content items, a respective dominant skin tone value;
determining the respective dominant skin tone for each of the first plurality of content items using the trained machine learning model and based at least in part on the respective dominant skin tone value and a plurality of threshold values.

3. The computer-implemented method of claim 1, wherein processing each of the first plurality of content items includes:
processing, using the trained machine learning model, each of the first plurality of content items to determine a respective region of interest in each of the first plurality of content items, and
wherein the respective dominant skin tone associated with each of the first plurality of content items is determined based on the respective region of interest.

4. The computer-implemented method of claim 1, further comprising:
obtaining, from the client device, a content item having a visual representation of at least a portion of a body part; and
processing, using the trained machine learning model, the content item to identify the portion of the body part as a region of interest in the content item and to determine a first dominant skin tone associated with the region of interest; and
causing, via a third user interface, the first dominant skin tone to be presented on the client device.

5. The computer-implemented method of claim 4, wherein the content item is captured by a camera associated with the client device.

6. The computer-implemented method of claim 1, further comprising:
receiving, from the client device, a content item having a visual representation of an overall beauty aesthetic, the overall beauty aesthetic including at least one area within the visual representation having an application of at least one beauty product;
determining a region of interest in the visual representation, the region of interest corresponding to the at least one area having the application of the at least one beauty product;
extracting, from the region of interest, at least one product parameter associated with the at least one beauty product that contributes to the overall beauty aesthetic;
identifying at least one additional content item from the second plurality of content items based at least in part on the at least one product parameter; and
providing for presentation, on the display of the client device, the at least one additional content item.

7. A computing system, comprising:
one or more processors; and
a memory storing program instructions, that when executed by the one or more processors, cause the one or more processors to at least:
obtain a first plurality of images, each of the first plurality of images including a visual representation of at least a portion of a body part;
for each of the first plurality of images:
process, using a trained machine learning model, the image to:
identify the portion of the body part as a region of interest in the visual representation of the image; and
determine a dominant skin tone value for the region of interest in the visual representation of the image;
determine, based at least in part on the dominant skin tone value and a plurality of threshold values, a dominant skin tone associated with the region of interest of the visual representation of the image; and
associate the dominant skin tone with the image.

8. The computing system of claim 7, wherein the program instructions, that when executed by the one or more processors, further cause the one or more processors to at least:
cause, via a first user interface, a plurality of target skin tones to be presented on a client device associated with a user;
obtain, via an interaction with the first user interface, a first target skin tone from the plurality of target skin tones;
identify a second plurality of images from the first plurality of images that are associated with the first target skin tone; and
cause, via a second user interface, the second plurality of images to be presented on the client device as responsive to a query.

9. The computing system of claim 7, wherein the dominant skin tone for each of the first plurality of images is determined based at least in part on a first dominant skin tone value and a plurality of threshold values.

10. The computing system of claim 7, wherein the program instructions, that when executed by the one or more processors, further cause the one or more processors to at least:
obtain, from a client device, a second image captured by a camera associated with the client device and including a second visual representation of at least a second portion of a second body part;
process, using the trained machine learning model, the second image to identify the second portion of the second body part as a second region of interest in the second image and to determine a second dominant skin tone associated with the region of interest; and
cause, via a first user interface, the second dominant skin tone to be presented on the client device.

11. The computing system of claim 10, wherein the second dominant skin tone is determined based at least in part on a second dominant skin tone value and a plurality of threshold values.

12. The computing system of claim 7, wherein the program instructions, that when executed by the one or more processors, further cause the one or more processors to at least:
obtain a content item having a second visual representation of an overall beauty aesthetic,
extract, from the second visual representation, at least one product parameter that contributes to the overall beauty aesthetic;
identify, based on the at least one product parameter, a second plurality of images from the first plurality of images, wherein each of the second plurality of images includes a respective third visual representation of a similar overall beauty aesthetic; and
cause, via a first user interface, the second plurality of images to be presented on a client device as responsive to a query.

13. The computing system of claim 12, wherein the program instructions, that when executed by the one or more processors, further cause the one or more processors to at least:
cause, via a second user interface, a plurality of target skin tones to be presented on the client device;
obtain, via an interaction with the second user interface, a first target skin tone from the plurality of target skin tones;
identify a third plurality of images from the second plurality of images that are associated with the first target skin tone; and
cause, via a third user interface, the third plurality of images to be presented on the client device.

14. The computing system of claim 12, wherein:
at least one beauty product contributes to the similar overall beauty aesthetic of a second image from the second plurality of images; and
the program instructions, that when executed by the one or more processors, further cause the one or more processors to at least:
receive, from a client device, a request to render the at least one beauty product on a user content item; and
present, on a display of the client device, a rendering of the at least one beauty product concurrent with a presentation of the user content item.

15. The computing system of claim 12, wherein the user content item is captured by a camera associated with the client device.

16. The computing system of claim 12, wherein the at least one product parameter includes at least one of:
a color;
a gloss;
an opacity;
a glitter;
a glitter size;
a glitter density;
a shape; or
an intensity.

17. A computer-implemented method, comprising:
causing, via a first user interface, a plurality of target skin tones to be presented on a client device associated with a user;
obtaining, via an interaction with the first user interface, a first target skin tone from the plurality of target skin tones;
obtaining a first plurality of content items stored and maintained in a data store, wherein each of the first plurality of content items is associated with a respective dominant skin tone that was determined by a trained machine learning model;
determining, based at least in part on the first target skin tone and each respective dominant skin tone, a second plurality of content items from the first plurality of content items, wherein the respective dominant skin tone associated with each of the second plurality of content items includes the first target skin tone; and
causing, via a second user interface, the second plurality of content items to be presented on the client device.

18. The computer-implemented method of claim 17, wherein each respective dominant skin tone was determined by:
processing, using the trained machine learning model, each of the first plurality of content items to determine a respective region of interest within each of the first plurality of content items;
determining, using the trained machine learning model, a respective skin tone value associated with each respective region of interest; and
determining, using the trained machine learning model and based at least in part on each respective skin tone value and a threshold value, each respective dominant skin tone associated each of the first plurality of content items.

19. The computer-implemented method of claim 17, wherein each respective region of interest includes a visual representation of at least a portion of a body part.

20. The computer-implemented method of claim 17, further comprising:
obtaining an input content item having a visual representation of an overall beauty aesthetic,
extracting, from the visual representation, at least one product parameter that contributes to the overall beauty aesthetic;
identifying, based on the at least one product parameter, a third plurality of content items from the first plurality of content items, wherein each of the third plurality of content items includes a respective second visual representation of a similar overall beauty aesthetic;
determining, based at least in part on the first target skin tone and each respective dominant skin tone associated with each of the third plurality of content items, a fourth plurality of content items from the third plurality of content items, wherein the respective dominant skin tone associated with each of the fourth plurality of content items includes the first target skin tone; and
causing, via a first user interface, the fourth plurality of images to be presented on a client device.
